(19) United States
(12) Patent Application Publication
(10) Pub. No.: US 2013/0339183 A1
(43) Pub. Date: Dec. 19, 2013

(54) SYSTEM AND METHOD FOR PERFORMING A DONATION

(71) Applicant: Philip Lockhart, Frisco, TX (US)

(72) Inventor: Philip Lockhart, Frisco, TX (US)

(21) Appl. No.: 13/918,834

(22) Filed: Jun. 14, 2013

Related U.S. Application Data
(60) Provisional application No. 61/660,422, filed on Jun. 15, 2012.

(51) Int. Cl. G06Q 30/02

(52) U.S. Cl. CPC G06Q 30/0279
USPC 705/26.8

(57) ABSTRACT

The disclosed embodiments include a method, apparatus, and computer program product for performing an online donation. For example, in one embodiment, a method for performing an online donation is disclosed that includes creating an organization account for enabling users to donate to an organization, populating a wish list with items desired by the organization, displaying one or more items on the wish list in response to receiving a user request to donate to the organization, and purchasing one or more items on the wish list for the organization in response to a user donation.

### CROSS REFERENCE TO RELATED APPLICATIONS

This application claims priority to U.S. Provisional Patent Application Ser. No. 61/660,422 filed on Jun. 15, 2013 entitled SYSTEM AND METHOD FOR PERFORMING A DONATION, the entire teachings of which are incorporated herein.

### BACKGROUND OF THE INVENTION

The present invention relates generally to the field of applications for computing devices, such as mobile phones, personal digital assistants, personal computers, laptops, portable media players and the like, and more particularly to a system and method for performing a donation.

Americans gave approximately $300 billion to charity last year. The majority of donations were from individuals. The largest sector to receive donations was religious organizations, then educational organizations. Giving has increased in 3 out of 4 years since 1971. In the U.S., the percentage of total fundraising that comes from online giving is currently about 6%. However, lots of people tend not to donate to charities as they feel that their donated money will not be wisely spent. Also, people are discouraged from donating as they do not have the ability to see or designate what their donation will be spent on.

Accordingly, the disclosed embodiments seek to provide a system, method, and computer program product for a user to perform a donation that overcomes one or more of the above problems.

### BRIEF SUMMARY OF THE INVENTION

The disclosed embodiments include a method, apparatus, and computer program product for performing an online donation. For example, in one embodiment, a method for performing an online donation is disclosed that includes creating an organization account for enabling users to donate to an organization, populating a wish list with items desired by the organization, displaying one or more items on the wish list in response to receiving a user request to donate to the organization, and purchasing one or more items on the wish list for the organization in response to a user donation. In certain embodiments, a donor may manually select items for donating to the organization. Alternatively, in some embodiments, a donor may select an eZbuy option that automatically generates a list of items for donating to an organization based on a donor specified budget. Still, in certain embodiments, the donor may specify a number of items to be donated or a particular category of items to be donated.

Additional embodiments, advantages, and novel features are set forth in the detailed description.

### BRIEF DESCRIPTION OF THE DIAGRAMS

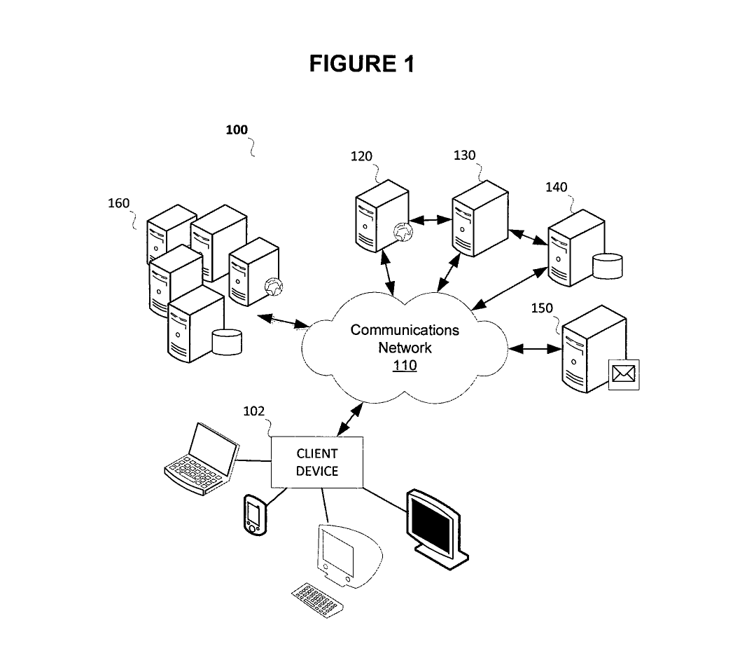

FIG. 1 is a schematic diagram illustrating a network environment in accordance with an embodiment of the invention;

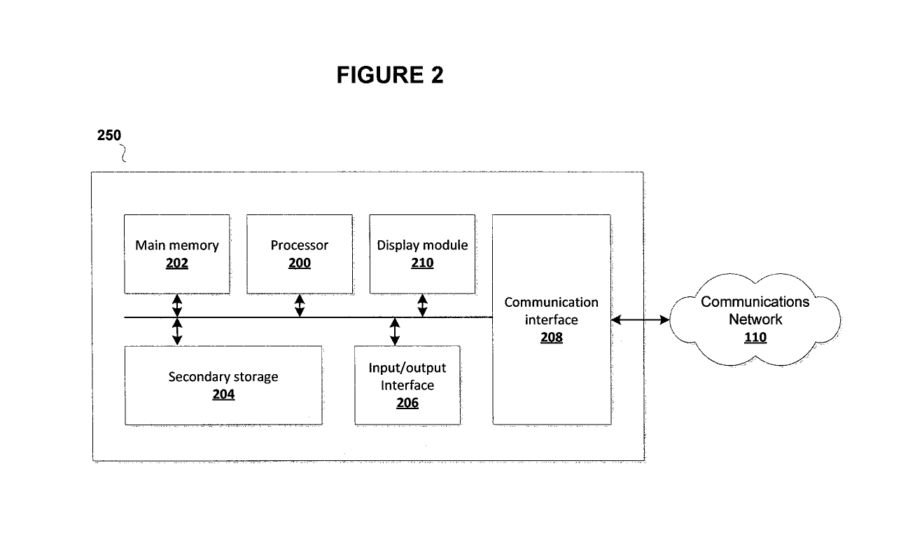

FIG. 2 is a schematic diagram illustrating a device in accordance with an embodiment of the invention;

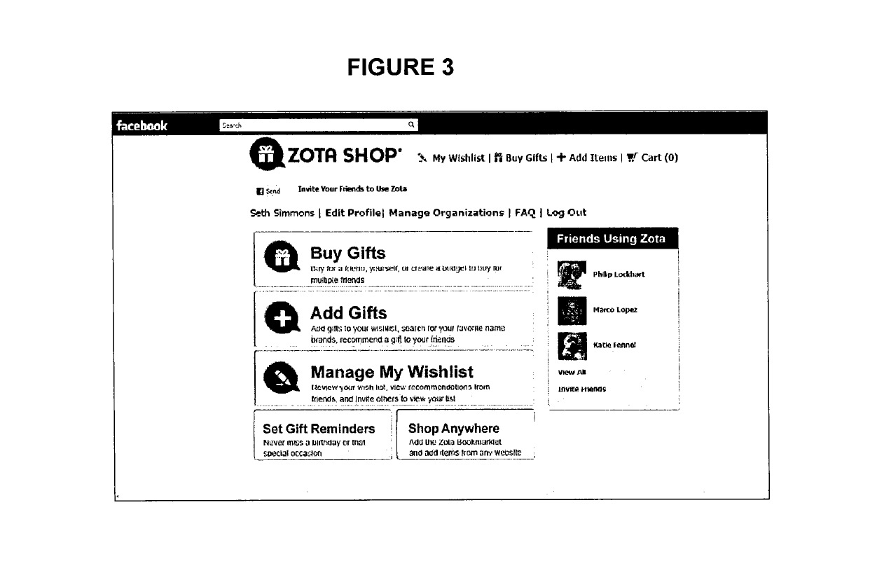

FIG. 3 is a diagram illustrating a user interface of an application in accordance with an embodiment of the invention;

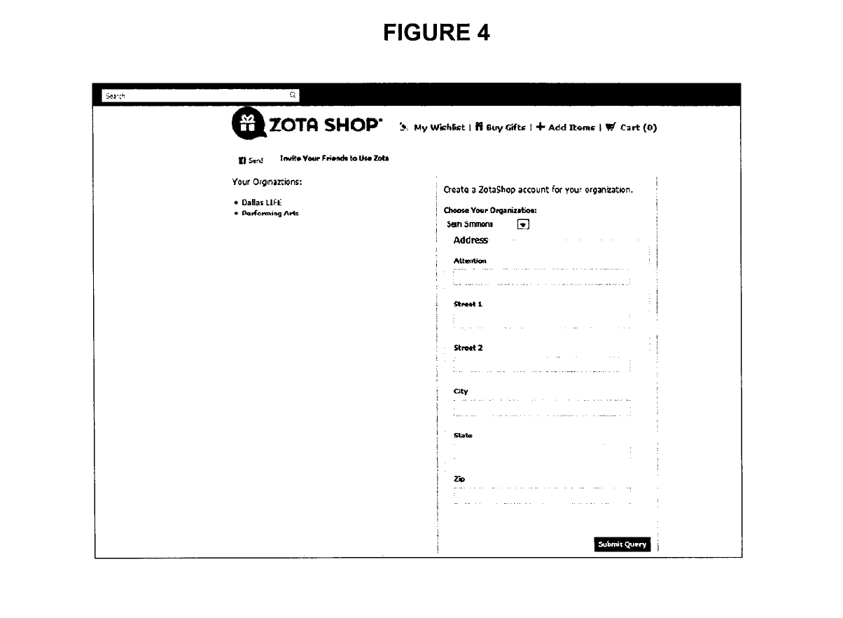

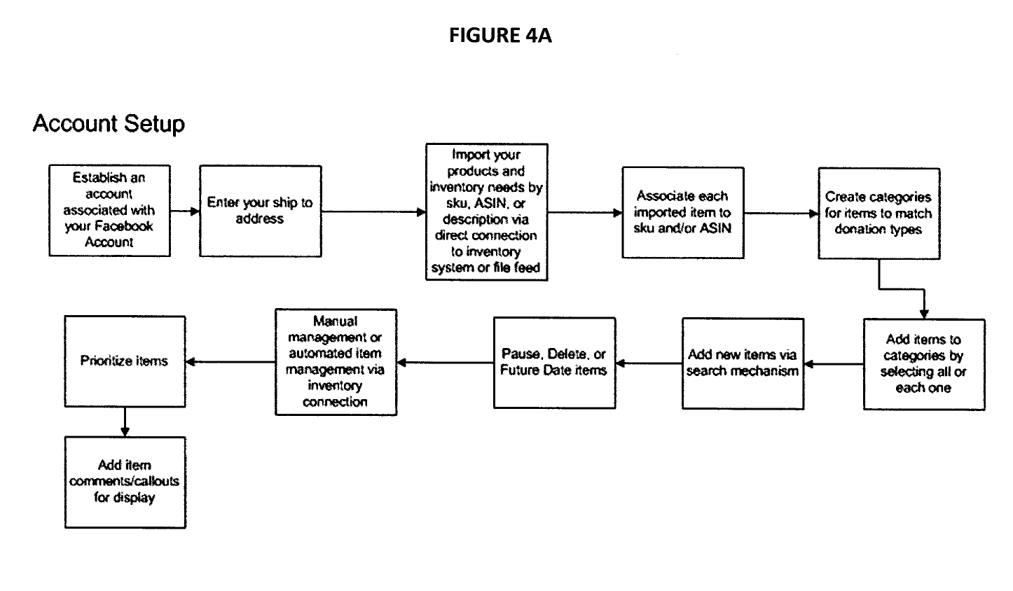

FIGS. 4 is a diagram illustrating an account setup page in accordance with an embodiment of the invention;

FIG. 4A illustrates a flowchart that depicts a process for setting up an account in accordance with an embodiment of the invention;

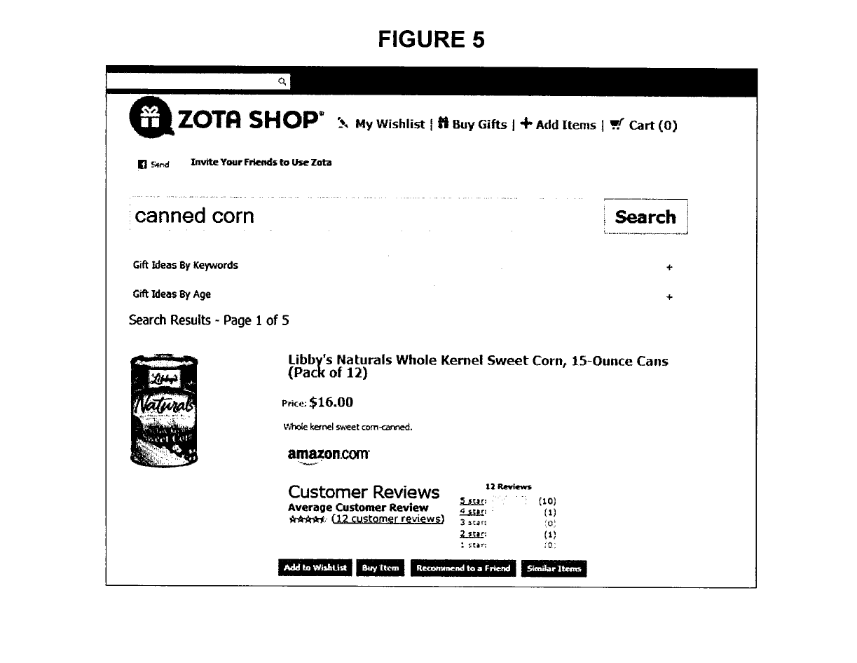

FIG. 5 is a diagram illustrating a product search page in accordance with an embodiment of the invention;

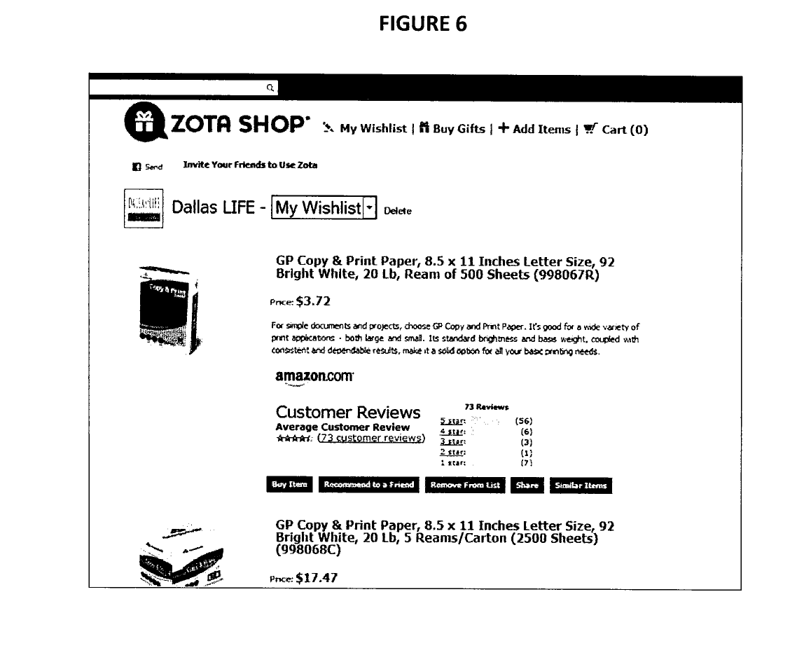

FIG. 6 is a diagram illustrating a wish list of an organization in accordance with an embodiment of the invention;

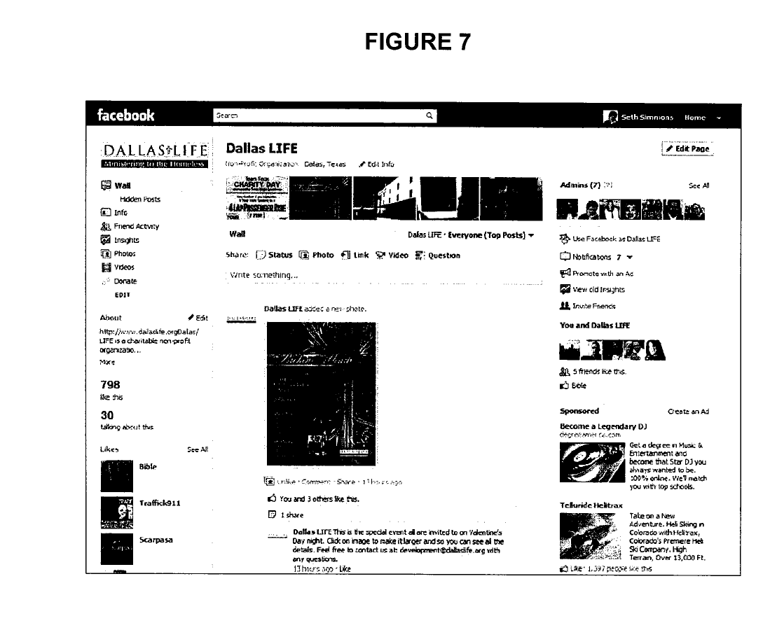

FIG. 7 is a diagram illustrating a social networking page of an organization in accordance with an embodiment of the invention;

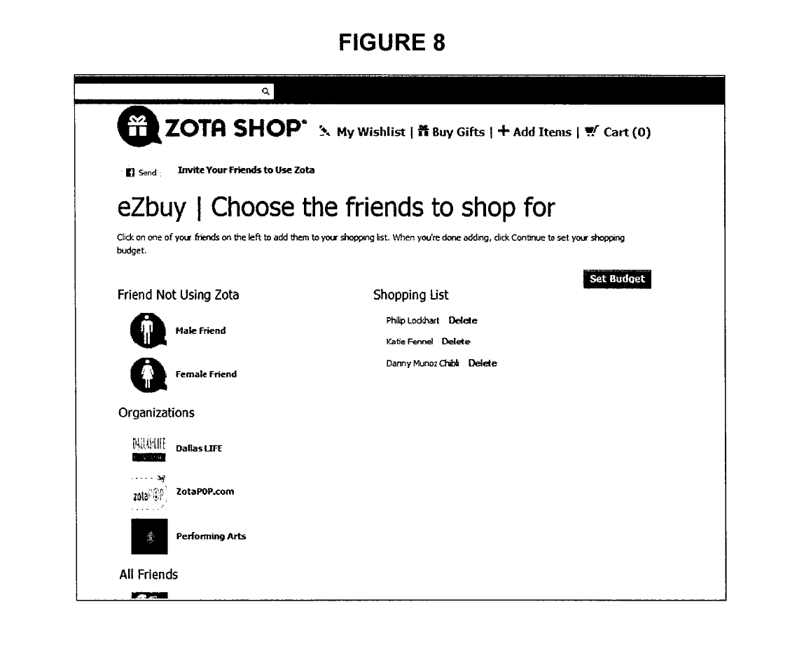

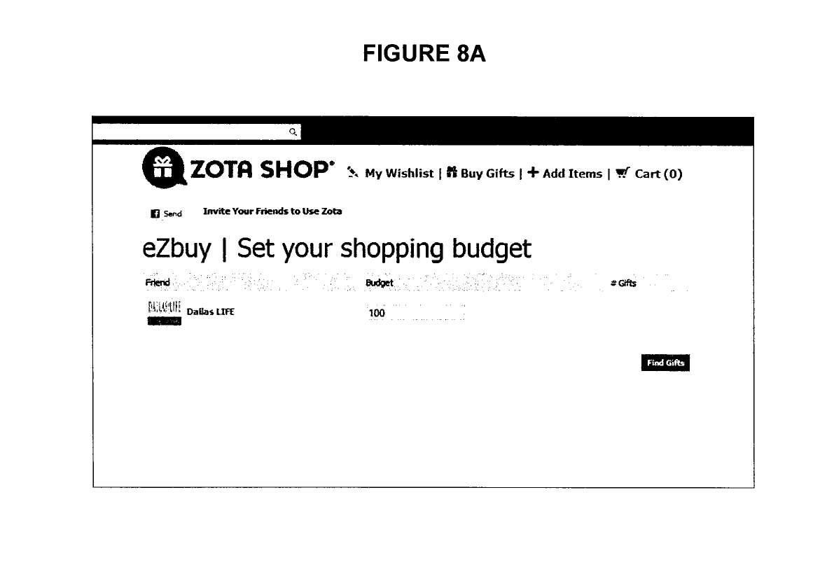

FIG. 8 is a diagram illustrating a user interface for selecting one or more organizations to donate to in accordance with an embodiment of the invention;

FIG. 8A is a diagram illustrating a user interface for entering budget amounts in accordance with an embodiment of the invention;

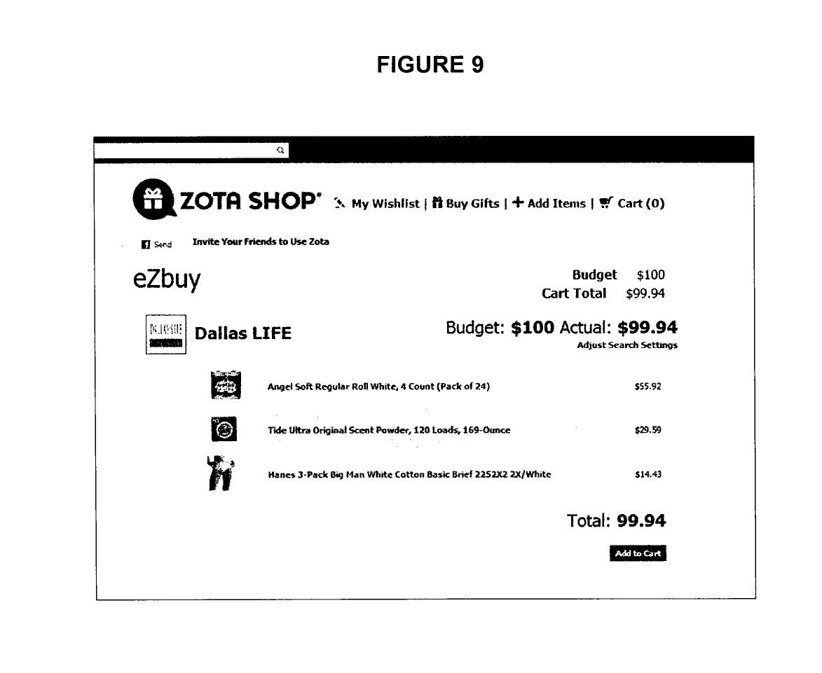

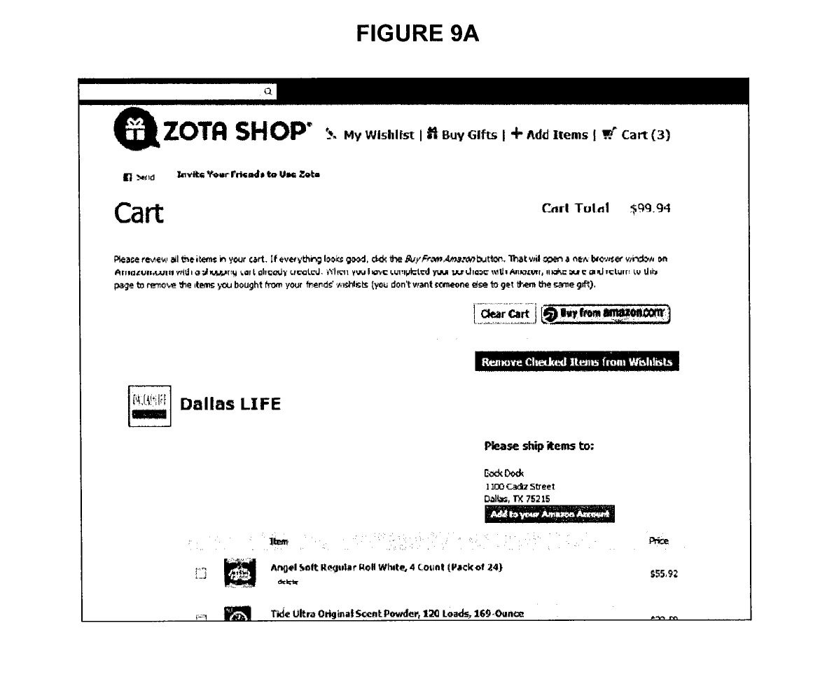

FIG. 9 is a diagram illustrating a user interface that displays selected items based on the budgeted amounts in accordance with an embodiment of the invention;

FIG. 9A is a diagram illustrating a user interface that displays the selected donation items in an electronic shopping cart in accordance with an embodiment of the invention;

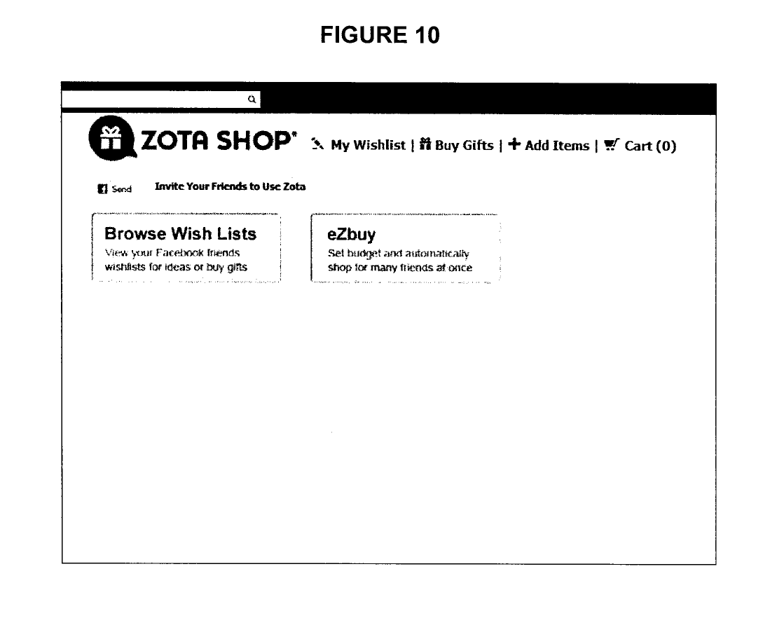

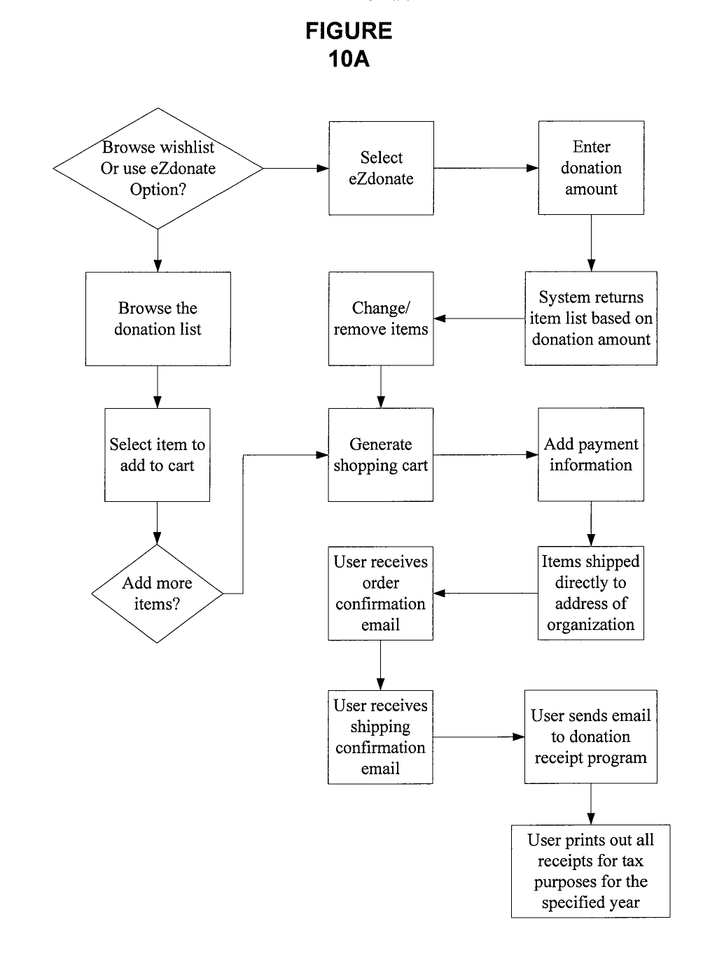

FIG. 10 is a diagram illustrating a couple of options for donations in accordance with an embodiment of the invention; and

FIG. 10A illustrates a flowchart that depicts the process for donating to an organization in accordance with one embodiment.

### DETAILED DESCRIPTION

The disclosed embodiments may assist a user in budgeting, ordering, and/or finding the least expensive options for automated purchasing within a budget. The disclosed embodiments and advantages thereof are best understood by referring to FIGS. 1-10A of the drawings, like numerals being used for like and corresponding parts of the various drawings. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and not intended to assert or imply any limitation with regard to the environment, architecture, design, or process in which different embodiments may be implemented.

FIG. 1 depicts an embodiment of a network environment 100 in which certain illustrative embodiments may be implemented. The network environment 100 includes a communications network 110 that enables a plurality of devices including a user device 102 to communicate data with other devices connected to the communications network 110. The communications network 110 may be any type of network including a combination of one or more of the following networks: a wide area network, a local area network, one or more private networks, the Internet, a telephone network such as the public switched telephone network (PSTN), one or more cellular networks, and wireless data networks. The communications network 110 may include a plurality of network nodes (not depicted) such as routers, network access points/gateways, switches, DNS servers, proxy servers, and other network nodes for assisting in routing of data/communications between devices.

In the depicted embodiment, the communications network 110 may provide data communications between one or more client devices such as a client device 102 and one or more server devices for enabling a user to perform the features and functions of the disclosed embodiments including, but not limited to, creating wish lists, searching for items to add to a wish list, reviewing the wish lists of others, setting a budget (per person/organization and total), automatically search/generate a list of items for one or more people/organizations based on the user's budget, and automatically purchase all the items on the list.

The client device 102 may be any type of device operable to communicate with the one or more servers over the communications network 110. For example, the client device 102 may be a laptop computer, a mobile phone or tablet, a desktop computer, a wired phone, a television, a set-top box, and/or any other device operable to communicate with the one or more servers over the communications network 110 for enabling a user to perform the features and functions of the disclosed embodiments.

The one or more servers may include one or more Web servers 120, Back-End servers 130, Database servers 140, and Mail servers 150. For example, in one embodiment, a user using the client device 102 interacts with a web site hosted by a Web server 120 in order to access the user's wish list and review the wish list of others. The client device 102 may interact with the Web server 120 utilizing a web browser application. Alternatively, the client device 102 may interact with either the Web server 120 or directly with another server device via an application installed on the client device 102 specially configured to enable to perform the features and functions of the disclosed embodiments. For instance, in some embodiments, a user's mobile device may be configured to include a mobile application and/or a user may download an application and install it on his/her personal computer.

In some embodiments, a Web server 120 may utilize one or more Back-End servers 130 to perform the features and functions of the disclosed embodiments. For example, the Back-End servers 130 may perform the actual query searches and provide the results to the Web server 120. The Web server 120 then formats the results into a format that is presentable to the user. Advantages of this configuration include the one or more Back-End servers 130 being able to serve multiple Web servers 120, easier management by splitting the interface code from the labor intensive code, and generally faster processing capabilities of the Back-End servers 130.

The Web server 120 and Back-End servers 130 may also utilize one or more Database servers 140. For example, in one embodiment, the Database servers 140 may store all the user account information data such as, but not limited to, information about user's wish list, information about the user's friends, previous purchases, such as how much was spent for a particular person and which items were purchased or which persons. The Database servers 140 may also store user information such as, but not limited to, a user profile, username, addresses, contact information, user preferences, and user billing information. The Web server 120 and/or Back-End servers 130 may also communicate with one or more communications servers such as, but not limited to, a Mail server 150, an SMS server (not depicted), and a fax server for sending and receiving communications.

In one embodiment, the Web servers 120, Back-End servers 130, and Database servers 140 may communicate over the communications network 110. This communication may be over the Internet and/or over a private network. In some embodiments, one or more of the above server devices may be directly wired to each other to provide direct communications between the devices. Still, in some embodiments, a single server/device may be configured to perform all of the features and functions of the disclosed embodiments.

In accordance with the disclosed embodiments, the one or more servers (120-140) may interact with any number of other computing devices 160 (e.g., other servers, mainframe, databases, etc.) over the communications network 110 to perform the features and functions of the disclosed embodiments. For instance, in accordance with one embodiment, the one or more servers (120-140) may interact with one or more servers hosting a social networking site, such as, but not limited to, Facebook®. For example, the disclosed embodiments may be implemented as a Facebook® application that is tied to Facebook® for enabling a user to recommend particular items to a friend, view a friend's wish list, post suggested or purchased items on a user's Facebook wall, review the Facebook information about a particular organization, and donate to an organization.

FIG. 2 depicts a schematic diagram illustrating some components of a server device 250 in accordance with the disclosed embodiments may be utilized to perform the features and functions of the disclosed embodiments. The server device 250 includes a processor 200, main memory 202, secondary storage unit 204, an input/output interface module 206, and a communication interface module 208. The processor 200 may be any number of or type of processors capable of executing instructions for performing the features and functions of the disclosed embodiments.

The input/output interface module 206 enables the server device 250 to receive user input and output information to a user or other devices. In some embodiments, the input/output interface module 206 also provides audio and video capabilities. The input/output interface module 206 may also enable external devices such as printers, USB flash drive, speakers, to be connected to the server device 250.

The communication interface module 208 enables the server device 250 to communicate with the communications network 110. For example, the network interface module 208 may include a network interface card for hardwiring the server device 250 to the communications network 110. In one embodiment, the communication interface module 208 may also include a wireless data interface for enabling the server device 250 to communicate wirelessly through a wireless access point or via a wireless network with the communications network 110. In some embodiments, the communication interface module 208 may also include a radiofrequency transceiver for sending and receiving cellular signals for voice communications.

In some embodiments, the server device 250 may optionally include a display module 210 to enable information to be displayed on an internal or external display device. For instance, the display module 210 may include instructions or hardware for providing touchscreen capabilities for receiving user input via the display device. In certain embodiments, the display module 210 may also include instructions for enabling multi-touch functionalities associated with a display device.

Main memory 202 is volatile memory that stores currently executing instructions/data, or instructions/data that are prefetched for execution. The secondary storage unit 204 is non-volatile memory for storing persistent data. The secondary storage unit 204 may be or include any type of data storage component such as a hard drive, a flash drive, or memory card. In one embodiment, the secondary storage unit 204 stores the computer executable code/instructions and other relevant data for enabling a user to perform the features and functions of the disclosed embodiments.

For example, in accordance with the disclosed embodiments, the computer executable code/instructions include, but not limited to, instructions for generating a user interface, instructions for parsing information received from a user, instructions for enabling a user to create a user account, create one or more wish lists, associate friends/organizations wish lists with the user's account, set a budget for purchasing gifts/donations to the one or more associated friends/organizations, automatically search/generate a list of items for a selected one or more friends/organizations that satisfy the user's budget, and automatically purchase every item on the list and have it shipped to the one or more friends/organizations. These instructions are passed from the secondary storage unit 204 to main memory 202 for enabling execution by the processor 200.

As an example, FIG. 3 depicts a diagram illustrating a user interface of an application in accordance with an embodiment of the invention. The depicted user interface includes options for buying gifts; viewing or modifying a wish list; viewing recommendations from others; inviting others to view your wish list; setting gifts reminders for birthdays, anniversary, and any other special occasion; editing your user profile; and managing a list of organizations. The user interface may also include a list of current friends that utilize the disclosed embodiments and an option for inviting more friends to utilize the disclosed embodiments.

As will be further discussed, the buying option enables a user to buy a gift for a single friend, a group of friends, the user, and an organization all based on a predetermined budget amount. The add gifts option enables a user to add gifts to their wish list, recommend a gift/item to one or more friends, and search for a particular product. In one embodiment, the disclosed embodiments may be linked to one or more retailers (e.g., Amazon.com®) for enabling a user to search and add items directly from the one or more retailers into the user's wish list.

Additionally, in certain embodiments, the disclosed application may include an option for enabling a user to add an item from any online retailer/website into the user's wish list. For instance, this option may include computer executable instructions for capturing any online retailer's web address, a URL to a direct page containing the item, an image of the item, the cost of the item, and be able to add all this information directly into the user's wish list.

FIGS. 4 is a diagram illustrating an account setup page in accordance with an embodiment of the invention. In the depicted embodiment, the user may set up an organization (e.g., a nonprofit) by creating an account for the organization. Once the account is set up, the user may populate the wish list of the organization for enabling donors to donate particular item to the organization.

FIG. 4A illustrates a flowchart that depicts a process for setting up an account in accordance with an embodiment of the invention. The process begins by establishing an account that is associated with the organization's Facebook® account. This enables a donor to view information about the organization via the organization's Facebook® account. During the setup process, the user may enter a shipping address associated with the organization for receiving donations. The user then imports products and inventory needs of the organization (i.e., create a wish list for the organization). Importing may be done by stock-keeping unit (SKU) number, Amazon® Standard Identification Number (ASIN), a description and/or image of a product from an inventory system or feed. The process associates each of the imported items with a SKU number or Amazon® Standard Identification Number (ASIN) if needed. The process creates categories and places each of the items into the categories to match donation types. The process enables a user to add new items to the donation wish list via a product search mechanism or by importing any item found on the Internet as will be further described below.

In one embodiment, the process enables a user to manually pause, delete, or future date items on the donation wish list. For instance, in one embodiment, the donation wish list may be tied to an inventory system. In some embodiments, the process may also be configured to automatically monitor the inventory system to pause, delete, or future date items on the donation wish list. For instance, the process may automatically pause an item on the list (i.e., not show or indicate in some way that a particular item is currently not needed). For example, if the inventory system indicates an overabundance of pillows, this may item be paused until a need is identified. The process may also future date a particular item. For example, cranberry sauce may be future dated and not be requested until around the holiday season. In addition, if a particular item is identified as being no longer needed or used, the process may delete the particular item.

In addition, in certain embodiments, items on an organizations wish list may automatically be added, deleted, or scheduled to be added or delete on a certain date. Quantities requested may be increased or reduced. Each of the foregoing may be accomplished in response to proximity to holidays or other dates, the amount of inventory in stock, the forecasted demand for inventory based on historical trends or anticipated events, the occurrence of a natural disaster or other crisis, the time of year, the current climate and weather, an increase in demand for charitable items, targeted “drives” for specific needs, or any other condition specified by a charity. Changes to a wish list may be driven by any of the foregoing factors alone or in combination, and may be automated based on a rules engine that operates in response to a user profile, inventory system, current orders, thresholds based on actual numbers, percentages, lead times, shelf life of products, or any other suitable factor. Batched or real time processes may be run to synchronize wish lists with inventory systems of charities. Ship to destinations may also be changed based on the location of distribution centers or other facilities and the needs of those facilities. Vendors to be used by donors may also be changed based on rebates or incentives offered to the charity by retailers.

In certain embodiments, the process may also prioritize the items on the donation wish list. For example, if a particular item is desperately needed, that particular item may be placed at the top of the wish list, flagged as being a priority item, or indicated in some other manner as being a priority item. The process may arrange the items on the donation list in order of priority.

In some embodiments, the process may also be configured to enable a user to add comments/callouts that can be displayed for a particular item. These comments may be pop-up comments, appear in a new pop-up window, or may be a link that provides additional information about a particular item. For example, the comments may indicate that a particular item is needed for a particular family and describe the family's situation.

FIG. 5 is a diagram illustrating a product search page in accordance with an embodiment of the invention. In the disclosed embodiments, a user may type in any search string for finding a desired product. In certain embodiments, in addition to keyword searching, a user may search for gifts ideas based on the age of the recipient. As stated above, the search query may be tied to one or more online retailer database such as, but not limited to, Amazon.com®. Once a desired product is located, a user may add it to their wish list, buy the particular item, recommend it to a friend, or search for similar items. In addition, in certain embodiments, the organization may specify particular sizes or age categories for particular items (e.g., need children shoes, need size 2 children pants, etc.). In certain embodiments, the organization may also specify an anti-wishlist of items that they do not want to receive. For example, if the organization does not provide services for animals, the organization may specify that it does not wish to receive any animal related products. Similarly, if the organization does not have the storage capacity, the organization may specify that it does not wish to receive large items such as furniture or mattresses.

FIG. 6 is a diagram illustrating a wish list of an organization in accordance with an embodiment of the invention. In a particular embodiment, a user associated with the organization may manually add items to their wish list, remove items from the wish list, recommend a particular item, purchase the item, or search for similar items. A donor viewing the organization's wish list may purchase the item for the organization or, in some embodiments, purchase similar items for the organization. Still, in some embodiments, a donor may recommend a particular item that may be of interest to the organization. For example, a donor in the information technology field may recognize a particular need of an organization and recommend a particular item to the organization that would assist in addressing that need.

FIG. 7 is a diagram illustrating a social networking page of an organization in accordance with an embodiment of the invention. The page includes information about the organization such as, but not limited to, the organization's activities, message, and friends/supporters. In the depicted embodiment, the page includes an option for a donor to donate to the organization. In certain embodiments, selection of the donation option may enable a donor to donate cash and/or donate items on the organization's wish list. In one embodiment, if a donor donates to a particular organization, a message may be posted on the organizations wall and/or may be posted on a donor's wall indicating that the donor has donated to the organization. In some embodiments, the particular items donated to the organization may be specified in the message. Alternatively, in some embodiments, a donor may choose to donate anonymously, thus, the system would be configured to not post any message regarding the donation or to not identify a donor in a posted message.

FIG. 8 is a diagram illustrating a user interface for selecting one or more friends and/or organizations to shop for in accordance with an embodiment of the invention. In the depicted embodiment, once a selected number of friends and/or organizations have been added to a shopping list, the user can proceed to set a budget.

As an example, FIG. 8A is a diagram illustrating a user interface for entering budget amounts in accordance with an embodiment of the invention. In the depicted embodiment, an actual budget amount may be entered for each organization in the shopping list. In certain embodiments, a number of gifts/donations may also be entered for each respective organization in the shopping list. For example, one friend/organization may receive 2 gifts, while other friends/organizations only each receive a single gift. In an alternative embodiment, the user may set a total budget and allocate percentages of the budget to each friend/organization in the shopping list. For example, one friend/organization may be allocated 25% of the total budget, another may be allocated 45% of the total budget, and the last one may receive a remaining percentage. Once the budget information is received, the disclosed embodiments will query each of the respective friend/organization wish list items and automatically generate a list of items for each of the friend/organization based on the allocated budget amount.

For example, FIG. 9 is a diagram illustrating a user interface that displays selected items based on the budgeted amounts in accordance with an embodiment of the invention. In the depicted embodiment, the total budgeted amount is $100 to be donated to a single organization. Based on the organization's wish list, the disclosed embodiments generated the suggested illustrated items for donation to the organization. In this embodiment, the cost for each item is displayed. In one embodiment, the user interface includes an option to search for alternative items to replace one or more of the suggested items. The alternative search option may be performed simultaneously for every item within the list or may be done on a per individual item basis.

FIG. 9A illustrates the selected donation items in an electronic shopping cart. The user can modify the shopping cart as desired. As depicted, in one embodiment, the shipping address of the organization is automatically tied to the electronic shopping cart for enabling the items to be directly shipped to the organization. In certain embodiments, a donor may add the shipping address of the organization to the donor's personal account with an online retailer (e.g., added to the donor's Amazon® account).

FIG. 10 is a diagram illustrating a couple of options for donations in accordance with an embodiment of the invention. In the depicted embodiment, a donor may browse the wish list of an organization and manually select items for donating to the organization, or a donor may select the eZbuy option that automatically generates a list of items for donating to the organization based on a donor specified budget.

For instance, FIG. 10A illustrates a flowchart that depicts the process for donating to an organization in accordance with the above options presented in FIG. 10. As illustrated in the flowchart, if a donor chooses the browse the wish list option, the process enables the donor the browse the donation list of the organization. The process enables the donor to select items to add to an electronic shopping cart for donating to the organization.

However, if the donor chooses the eZbuy option, the process will automatically perform the eZdonate features of the disclosed embodiments. The process will request a donation amount from the donor. In some embodiments, the number of items to be donated may also be specified. The process will then query the organization's donation wish list to create a list of potential item(s) for donation best matching the entered donation budget amount. In one embodiment, the process includes instructions for calculating and including shipping cost and taxes (if any) into the budgeted amount to ensure that the total cost is within a user's specified budget. The process then presents the selected items to the donor, wherein the donor can modify the list of selected items as previously described. In one embodiment, if there are not enough items on the wish list to fulfill the budgeted amount, the remainder may be filled with a cash donation.

Once the above process has completed, the process will create a shopping cart listing the selected items for donation. Again, the donor may be given the option to edit the shopping cart by removing items, replacing items, and/or changing the quantity of items in the shopping cart. Once a donor is satisfied, the donor may place the order. The process is configured to automatically place the order for each of the items in the shopping cart, have them shipped directly to the organization (if so desired by the donor), and bill the donor for the ordered amount.

The process may send the donor a confirmation of the donation/order via electronic mail, text messaging, or by any other notification medium. The process may also send a donor confirmation of shipping information including when an item is shipped, its expected arrival date, and when the item actually arrived.

In certain embodiments, the process may also transmit a donation receipt to the donor enabling the donor to claim a donation tax credit.

In some embodiments, the process may also be bill a vendor or perform other accounting features based on the sale. For example, the process may perform an accounting feature to account for a certain percentage of the sale as a commission for generating the sale with a partnered vendor.

Advantages of the disclosed embodiments include, but are not limited to, making the donation process easier by providing centralized wish lists of organizations, the ability to donate to one or more organizations based on a predetermined budgeted donation amount, the ability to select the desired items for donations to a particular organization. The advantages enable a donor to know exactly how his/her donation money is being spent, to cut administrative cost or middle man cost in the donation process, and to meet the clear specified needs of an organization.

The illustrative embodiments can take the form of an entirely hardware embodiment, an entirely software embodiment or an embodiment containing both hardware and software elements. Furthermore, the illustrative embodiments can take the form of a computer program product accessible from a computer-usable or computer-readable medium providing program code for use by or in connection with a computer or any instruction execution system. For the purposes of this description, a computer-usable or computer-readable medium can be any tangible non-transitory apparatus that can store the program for use by or in connection with a system or electronic device.

The previous detailed description is of a small number of embodiments for implementing the invention and is not intended to be limiting in scope. For example, while specific details about the above embodiments have been described, the above hardware and software descriptions are intended merely as example embodiments and are not intended to limit the structure or implementation of the disclosed embodiments.

In addition, those skilled in the art will recognize that the present teachings are amenable to a variety of modifications and/or enhancements. While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. Such modifications are intended to be covered within the true scope of the present teachings.

In addition, the flowcharts, sequence diagrams, and block diagrams in the figures illustrate the architecture, functionality, and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to explain the principles of the invention and the practical application, and to enable others of ordinary skill in the art to understand the invention for various embodiments with various modifications as are suited to the particular use contemplated. The scope of the claims is intended to broadly cover the disclosed embodiments and any such modification.

1. A method for performing an online donation, the method comprising:
creating an organization account for enabling users to donate to an organization;
populating a wish list with items desired by the organization;
displaying one or more items on the wish list in response to receiving a user request to donate to the organization; and
purchasing one or more items on the wish list for the organization in response to a user donation.

2. The method of claim 1, further comprising providing an option on a social network page associated with the organization for enabling the user to donate to the organization.

3. The method of claim 1, further comprising providing a notification of a donation from a user on at least one of a social network page corresponding to the organization and the user.

4. The method of claim 3, wherein the notification of the donation includes items selected by the user for donation to the organization.

5. The method of claim 1, wherein the one or more items on the wish list that is displayed in response to receiving the user request to donate to the organization is selected automatically based on a user indicated donation amount.

6. The method of claim 5, further comprising calculating and including any costs associated with shipping and taxes to ensure that the one or more displayed items is within the user indicated donation amount.

7. The method of claim 1, wherein populating the wish list with items desired by the organization includes an option for receiving a product identification number.

8. The method of claim 1, wherein populating the wish list with items desired by the organization includes an option for searching a third-party vendor site for a desired item.

9. The method of claim 1, wherein populating the wish list with items desired by the organization includes an option for providing a link to any product page on the Internet.

10. The method of claim 1, wherein populating the wish list with items desired by the organization includes an option for future dating a desired product.

11. The method of claim 1, wherein populating the wish list with items desired by the organization includes an option specifying a desired number of an item.

12. The method of claim 1, further comprising monitoring an inventory database associated with the organization for updating the wish list.

13. The method of claim 1, further comprising automatically updating the wish list based on a forecasted demand for a particular item based at least one of historical trends and an anticipated event.

14. The method of claim 1, wherein populating the wish list with items desired by the organization includes an option to enable organization to add comments to a particular item that can be displayed with the particular item to indicate a particular need for the particular item.

15. The method of claim 1, further comprising populating an anti-wish list of items that the organization does not desire to be donated.

16. The method of claim 1, further comprising searching for an alternative item for the one or more displayed items in response to receiving a user request to search for an alternative item.

17. The method of claim 1, wherein purchasing the one or more items on the wish list for the organization in response to the user donation comprises automatically placing an order for each of the items to be shipped directly to the organization and billing a cost to a donor.

18. The method of claim 1, further comprising billing a referral fee to a third party vendor in response to completing a transaction that involves one or more items purchased from the third party vendor.

19. A system comprising:
memory for storing data and executable instructions;
a processor configured to execute the executable instructions to:
create an organization account for enabling users to donate to an organization;
populate a wish list with items desired by the organization;
display one or more items on the wish list in response to receiving a user request to donate to the organization; and
purchase one or more items on the wish list for the organization in response to a user donation.

20. A non-transitory computer readable medium comprising computer executable instructions that when executed causes one or more machines to perform operations comprising:
creating an organization account for enabling users to donate to an organization;
populating a wish list with items desired by the organization;
displaying one or more items on the wish list in response to receiving a user request to donate to the organization; and
purchasing one or more items on the wish list for the organization in response to a user donation.
